(19) United States
(12) Patent Application Publication
(10) Pub. No.: US 2009/0104007 A1
(43) Pub. Date: Apr. 23, 2009

(54) AUTOMATED GUIDED VEHICLE FOR ROLLS OF NEWSPRINT

(76) Inventors: Kenji Umezawa, Osaka (JP); Takashi Murata, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/245,074

(22) Filed: Oct. 3, 2008

(30) Foreign Application Priority Data
Oct. 18, 2007 (JP) 2007-271334

(51) Int. Cl. B60P 1/02; B66F 9/06

(52) U.S. Cl. 414/349

(57) ABSTRACT

An automated guided vehicle for loading and unloading a rotary press with various types and widths of rolls of newsprint or other paper irrespective of their diameters. The vehicle has a traveling carriage for automatically transporting a newsprint between a storage area and the setting area in a rotary press machine. It includes a hoisting/lower unit which hoists and lowers the newsprint in the vertical direction into and away from registering with the paper holding arms of the rotary press machine. The hoisting/lowering unit includes two hoisting/lowering frames parallel to a traveling road surface, and the central axis between the fixed and movable paper holding arms of the rotary press paper. The frames are kept spaced apart by an arc-shaped connecting member. Linear guides on upper surfaces of the two hoisting/lowering frames slidably support a moving table bridging over the linear guide 144 which supports the roll and permits the supported roll to be axially displaced into engagement with the support cones of the fixed holding arms.

### FIELD OF THE INVENTION

The present invention relates to an automated guided vehicle for transporting rolls of newsprint or other printing paper, which automatically transports a roll of newsprint or other printing paper between a storage area and a setting area for a rotary press machine, and more specifically relates to a newsprint automated guided vehicle, comprising a hoisting/lowering unit which hoists and lowers said roll of newsprint in the vertical direction for connection to/removal from a rotary press machine.

### BACKGROUND OF THE INVENTION

In a newspaper publishing facility and the like, an automated guided vehicle, which supplies rolls of fresh newsprint to a rotary press machine or removes used rolls of newsprint has been generally used. Wide rolls of newsprint having a width of 1626 mm (identified in the drawings by the character R3), medium rolls of newsprint (identified by R3) having a width of 1219 mm, and narrow rolls of newsprint (R2) having a width of 813 mm are generally used.

FIG. 7 is a schematic side view of conventional equipment showing a state where a newsprint automated guided vehicle, which has been used (hereinafter referred to as “automated guided vehicle”) attaches a fresh roll of narrow newsprint R2 to a rotary press machine having fixed and movable paper holding arms A and B. An automated guide vehicle 200 includes a traveling carriage 220, which automatically transports rolls of newsprint by being controlled by electromagnetic waves, generated by an electromagnetic induction line and by flux and reflection tape generated by a magnetic tape, both laid on the road surface F on which the vehicle travels. The mechanism includes a hoisting/lowering unit 240, which hoists and lowers the newsprint roll R2 carried by the traveling carriage 220 in the vertical direction.

This hoisting/lowering unit 240 includes hoisting/lowering base 241 and hoisting/lowering means 243 having an inner arm 243a and an outer arm 243b forming an X-shaped pantograph which displaces the hoisting/lowering base 241. Further, on the upper surface of the hoisting/lowering base 241 is provided two linear guides 244 in parallel with each other and parallel to a central axis D extending between the central axes of the side cone A1 attached to the fixed side winding paper holding arm A and the moving side cone B1 of the displaceable holding arm B. A moving table 245 is arranged so as to bridge over the linear guides 244 and slide therealong to support a newsprint roll R2 for displacement along the central axis when the base is at its upper limit position.

In operation, the automated guided vehicle 200 loads the roll of newsprint R2 onto the moving table 245 at a storage station for newsprint rolls. The vehicle is advanced to under a fixed side winding paper holding arms A and B provided opposite each other in the paper feeding device in a rotary press machine. The hoisting/lowering unit 240 hoists the roll of newsprint roll R2 on the moving table 245 so that the central axis C1 of a core C of the newsprint roll R2 is disposed at a position aligned with the central axis D, extending between the central axis of a fixed side cone A1 attached to the fixed side winding paper holding arm A and the central axis of a moving side cone B1 attached to the moving side winding paper holding arm B. The moving side winding paper holding arm B is horizontally moved in a direction of the fixed side winding paper holding arm A so that the moving side cone B1 is fitted to one opening end portion C2 of a wound core C of the newsprint Roll R2. Further, when the moving side winding paper holding arm B is moved in the direction of the fixed side winding paper holding arm A, a moving table 245 loading the newsprint Roll R2 is slid on a linear guide 244 of the hoisting/lowering base 241 and the newsprint Roll R2, causing the other opening end portion C3 of a wound core C of the newsprint Roll R2 to be fitted to the fixed side cone A1 of the fixed side winding paper holding arm A so that the engagement of the newsprint Roll R2 to the paper feeding device of the rotary press machine is completed. As described above, when the radius of the newsprint Roll R2 is larger than the radius of the moving side winding paper holding arm B, rolls of newsprint can be attached to and recovered from the rotary press machine without difficulty, even in the event that the roll of paper was a width smaller than the length of the base 241.

FIG. 8 is a schematic side view showing a state where the same automated guided vehicle 200 shown the above-described FIG. 7 recovers an empty roll R3 of wide newsprint from the rotary press machine. Since the axial length of the roll R3 is sufficiently longer than the hoisting/lowering base 241, the automated guide vehicle 200 can be advanced to under the fixed side winding paper holding arm A and the moving side winding paper holding arm B of the rotary press machine. The moving side winding paper holding arm B is retracted so that it moves away from the fixed side winding paper holding arm A whereby the empty roll R3 is released from sandwiching between the fixed side winding paper holding arm A and the moving side winding paper holding arm B of the rotary press machine. The hoisting/lowering base 241 is lowered so that the traveling carriage 220 may be automatically transported to the storage station for the rolls of newsprint, as shown in Japanese Patent No. 3162661 (see page 3 and FIG. 1 particularly).

However, in the above-mentioned automated guided vehicle 200, when the narrow width roll of newsprint R2 (or the medium width roll R4, not shown) has a radius smaller than that of the moving side winding paper holding arm B, and is attached to the rotary press machine, as shown in FIG. 9, the moving side winding paper holding arm B collides with an edge of the hoisting/lowering base 241 at a portion E when bringing the moving side winding paper holding arm B toward the fixed side winding paper holding arm A, there was a problem that the newsprint roll R2 or having a small diameter cannot be attached or removed.

Therefore, to attach and remove the rolls of newsprint of narrow or medium width to and from a rotary press machine with a common automated guided vehicle 200, it was necessary to mount a bulk increasing base 250 for avoiding interference between the moving side winding paper holding arm B of the rotary press machine and the hoisting/lowering base 241 on a moving table 245 as shown in FIG. 10. Since this operation was manually made, the efficiency was bad and the operation was costly. Further, in a case where the height from a traveling road surface F to the feeding device of a rotary press machine is limited, the height of the bulk increasing base 250 becomes an obstacle. Thus there was a problem that the automated guided vehicle 200 cannot be advanced to under a paper feeding device in a rotary press machine.

Further, in a conventional automated guided vehicle 200, when the hoisting/lowering unit 240 is lowered, the open portion of a traveling carriage 220 is covered by the hoisting/lowering base 241 and table 245. Thus, observation of the inside of the traveling carriage 220 is impossible. For example, maintenance of a caster, a hoisting/lowering unit 240 and the like was impossible. Further, since the hoisting/lowering base 241 has considerable weight the weight of the automated guided vehicle 200 itself becomes heavy, the energy consumption during traveling and hoisting/lowering is large and the energy efficiency was bad.

### SUMMARY OF THE INVENTION

Accordingly, an object of the present invention is to provide an automated guided vehicle, which can be adapted to various types of rolls of newsprint such as narrow, medium and wide, irrespective of their diameters and in which low bedding, weight lightening and energy saving are obtained.

The invention solves the above-mentioned problems by providing an automated guided vehicle comprising a traveling carriage, which supports a newsprint roll and automatically transports the supported roll between a storage station and into registry with paper holding arms in the setting area in a rotary press machine. A hoisting/lowering unit is mounted on the traveling carriage, which hoists and lowers the supported roll of newsprint into and out of registry with a position between opposed winding paper holding arms of the rotary press machine, in which position the supported roll may be engaged with and disengaged from the opposed winding paper holding arms. The invention is characterized in that the hoisting/lowering unit includes two spaced-apart hoisting/lowering frames provided in parallel to a traveling road surface, hoisting/lowering means, which hoisting/lowering raises and lowers the hoisting/lowering frames, an arc-shaped connecting member, which keeps a spacing between the two hoisting/lowering frames to avoid interference with the winding paper holding arms, linear guides respectively formed on upper surfaces of said two hoisting/lowering frames and a moving table, bridging over said linear guide, slides along the guides.

Further, the invention solves the above-mentioned problems by providing a pair of arms forming an X-shaped pantograph, one end of each is respectively pivoted to the hoisting/lowering frame or the hoisting/lowering supports and the other end of each slides along the hoisting/lowering frame or the hoisting/lowering supports.

The invention provides pair of X-shaped pantographs, each having an inner arm and an outer arm. The two inner arms and the two outer arms have inner and outer distance keeping rods disposed so as to avoid the interference with the winding paper holding arms of said rotary press machine when said hoisting/lowering frames are positioned at the upper position of a hoisting/lowering range where the supported paper roll is in registry with the arms.

Since a newsprint automated guided vehicle according to the present invention comprises a traveling carriage, which automatically transports a newsprint roll between a storage station and the setting area in a rotary press machine, and a hoisting/lowering unit mounted on said traveling carriage, which hoists and lowers the newsprint roll into and out of registry with the opposed winding paper holding arms of a rotary press machine, attachment and recovery operations of the newsprint with respect to a rotary press machine can be performed without the manpower. Therefore, the attachment and recovery operations of the newsprint can be remarkably reduced in cost and, additionally, the following effects of the present invention can be obtained.

Since the hoisting/lowering unit includes two spaced-apart hoisting/lowering frames provided in parallel to a traveling road surface, and hoisting/lowering means for the hoisting/lowering frames, an arc-shaped connecting member keeps the spacing between the two hoisting/lowering frames and is configured to avoid interference with the winding paper holding arms of the rotary press. Also, linear guides on upper surfaces of the two hoisting/lowering frames slidably support a moving table, bridging between the linear guides, which avoids interference between the winding paper holding arms of the rotary press and the hoisting/lowering unit. Thus, a newsprint automated guided vehicle of the present invention can be adapted to various rolls of newsprint or other paper which may range in type, width or quantity, and energy saving can be realized and the maintenance properties improved.

Further, since the hoisting/lowering means has a pair of X-shaped pantographs, in each of which one end is pivoted either to one end portion of the hoisting/lowering frame or to said hoisting/lowering supports and the other ends of which are slid along said hoisting/lowering frame or the hoisting/lowering supports, when the hoisting/lowering means is lowered, the hoisting/lowering frames and the pantograph arms are all accommodated within the bed of the traveling carriage. Thus, the bed of the automated guided vehicle can be made lower.

Since the pair of X-shaped pantographs are each composed of an inner arm and an outer arm which respectively have an inner distance keeping rod and an outer distance keeping rod disposed so as to avoid the interference with the winding paper holding arms of the rotary press machine when the hoisting/lowering frames are positioned in the upper limit of a hoisting/lowering range, the distance between the inner arm and the outer arm is kept to a required spacing. Thus, parallelism of the hoisting/lowering frame is kept, together with the effects obtained by the arc-shaped connecting member referenced above.

In summary, the present invention is adapted to load and unload the opposed paper holding arms of a rotary press machine with rolls of the various types of newsprint irrespective of their different widths and the invention provides diameters, low bedding, weight lightening and energy saving and the maintenance properties are improved. Various concrete embodiments of the present invention may be adopted.

### BRIEF DESCRIPTION OF THE DRAWINGS

FIG. 1 is a perspective view of a traveling carriage of an automated guided vehicle according to the present invention;

FIG. 2 is a rear view of the hoisting/lowering unit of the automated guided vehicle shown in FIG. 1 viewed from an arrow direction of 11, with portions of a rotary press machine illustrated in broken lines;

FIG. 3 is a front view similar to FIG. 2 viewed from an arrow direction of III shown in FIG. 1;

FIG. 4 is a side view when a roll of newsprint of various widths is inserted into a press having a fixed paper holding arm to the left;

FIG. 5 is a side view when the roll of newsprint has been engaged with both of the holding arms;

FIG. 6 is a side view when a roll of newsprint of various widths has been engaged with the holding arms of a press having the fixed holding arm on the right;

FIG. 7 is a side view when a conventional automated guided vehicle attaches a fresh roll of newsprint of narrow width;

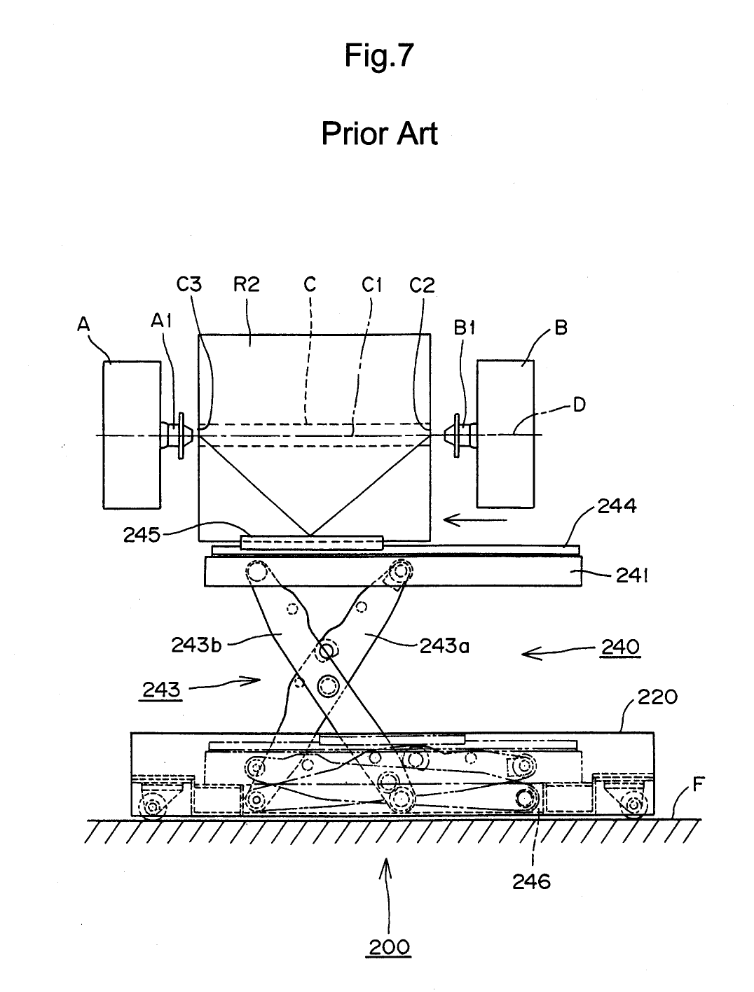

FIG. 8 is a side view of a conventional automated guided vehicle when the vehicle recovers a used roll of newsprint of wide width;

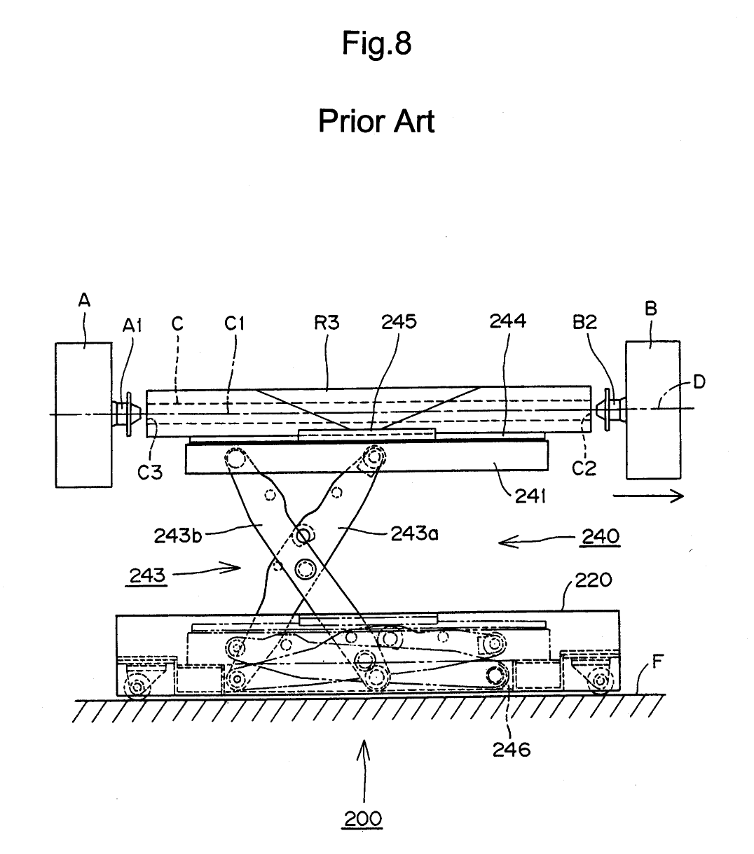

FIG. 9 is a side view when a conventional automated guided vehicle is positioned for recovery of a used roll of medium width; and

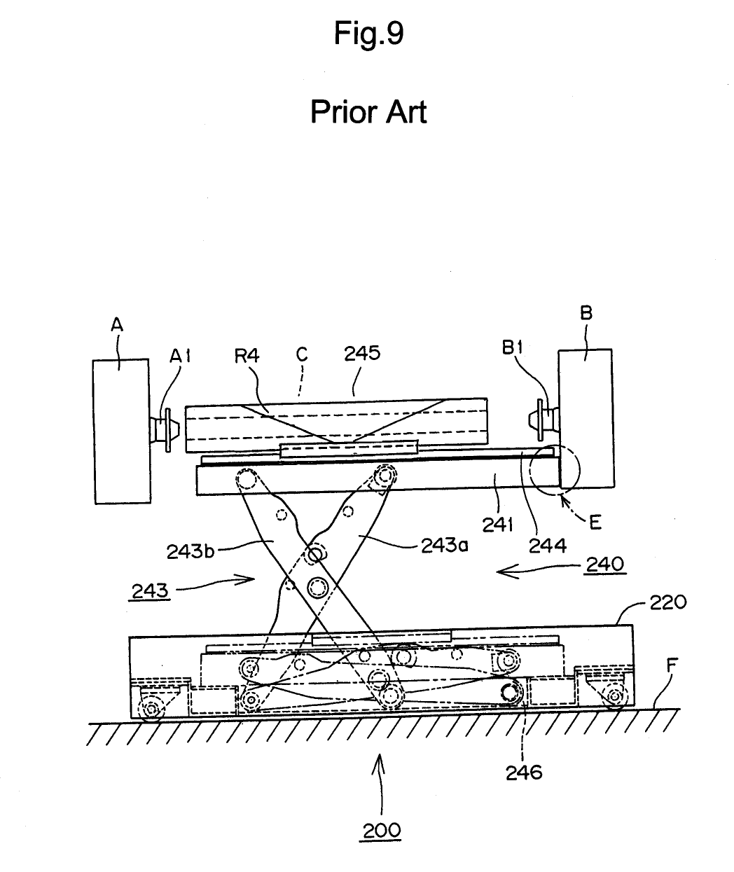

FIG. 10 is a side view when a conventional automated guided vehicle is in position for recovery of a used roll of narrow width, showing the use of a bulk-increasing base.

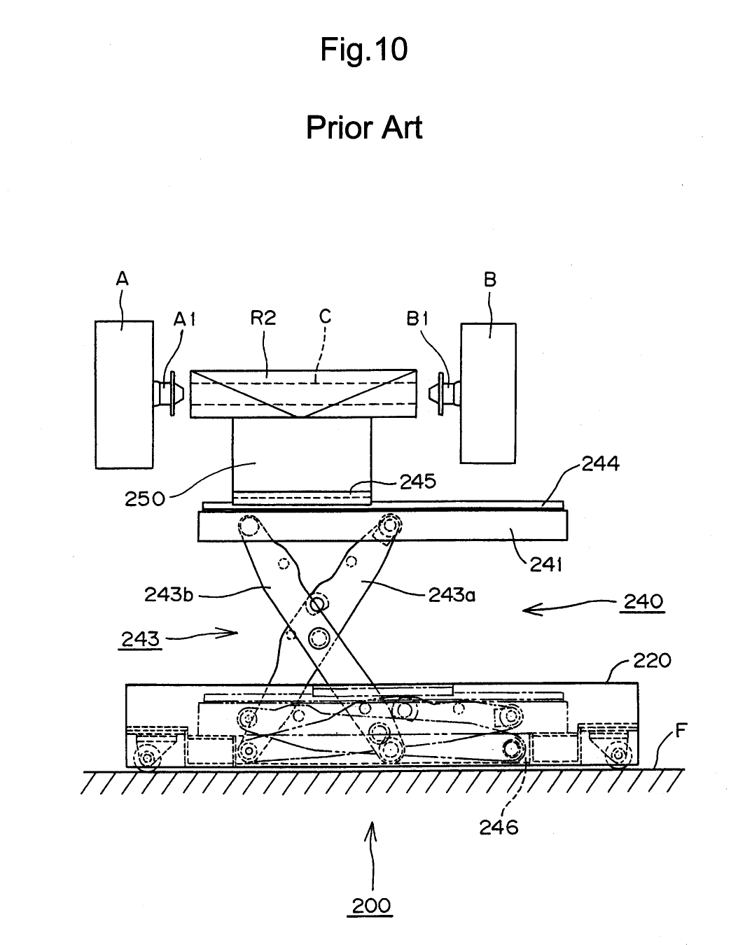

### PREFERRED EMBODIMENTS OF THE INVENTION

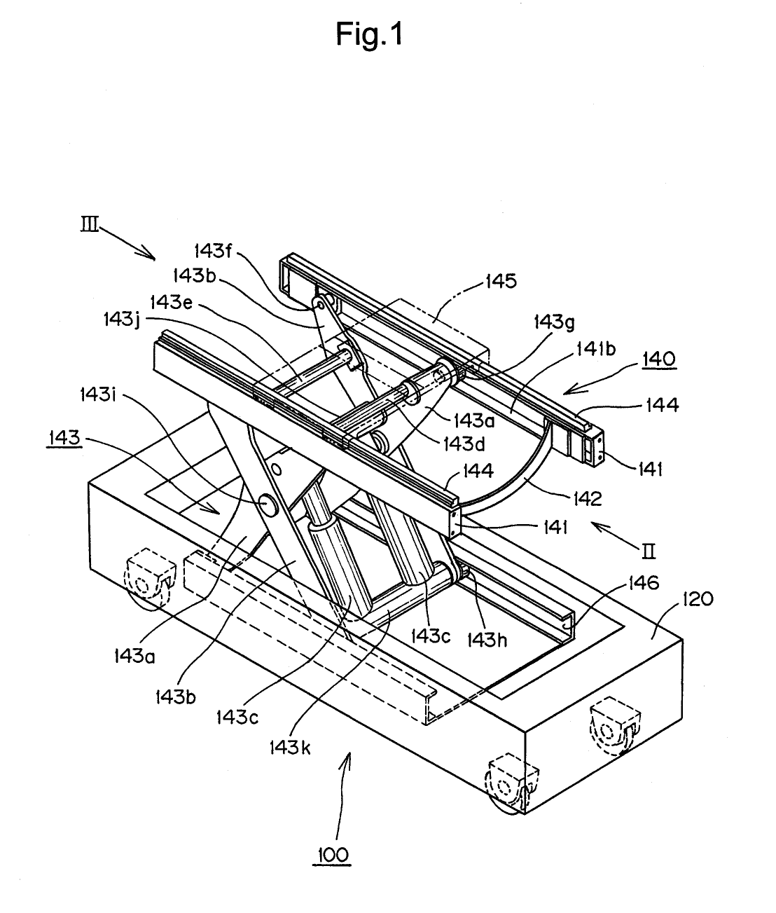

As shown in FIG. 1, an automated guided vehicle 100 according to the present invention comprises a traveling carriage 120, which automatically transports a newsprint between a storage station and a setting area in a rotary press machine, and a hoisting/lowering unit 140 mounted on the traveling carriage 120, which hoists and lowers the newsprint in the vertical direction for attachment and removal to and from a pair of opposed winding paper holding arms of the rotary press machine. It should be noted that the carriage has side walls defining a recess which accommodates the hoisting/lowering unit 140 as it is actuated between a lowered position and a hoisted position.

The hoisting/lowering unit 140 includes two hoisting/lowering frames provided in parallel to a traveling road surface, hoisting/lowering means 143, which hoisting/lowering drives the hoisting/lowering frames 141, an arc-shaped connecting member 142, which keeps a distance between the two hoisting/lowering frames, linear guides 144 respectively formed on upper surfaces 141 of the two hoisting/lowering frames 141 and a moving table 145, bridging over the linear guide rails 144, and which is able to slide on the rails to permit newsprint rolls to be displaced longitudinally along the frames.

The hoisting/lowering means 143 used in the example of the present invention has a pair of X-shaped pantographs, each including an outer arm 143b, the upper end of which is pivoted onto one end sides of slide rails 141a formed on opposed inside surfaces of the two hoisting/lowering frames 141 by pivoting pins 143f and an inner arm 143a, the upper end of which slides through inner roller 143g while guided by slide rail 141b.

The outer arms 143b and the inner arms 143a are pivoted by a connecting pin 143j at substantially their center. The lower ends of the outer arms 143b are slidably supported on hoisting/lowering bottom supports 146 through outer rollers 143h and the upper ends of the inner arms 143a are pivoted by pivoting pins (not shown) on one end side of the hoisting/lowering bottom supports.

Further, to maintain spacing between the pair of X-shaped pantographs, the inner arms 143a are securely provided with an inner distance keeping rod 143d and the outer arms 143b are securely provided with an outer distance keeping rod 143e. If the hoisting/lowering frame is positioned in the vicinity of upper limit of a hoisting range, the inner distance keeping rod 143d and the outer distance keeping rod 143e are attached to positions lower than the lowermost surface of an inner circumference of an arc-shaped connecting member 142. Further, a hoisting/lowering supporting rod 143j is securely provided at a position under the inner distance keeping rod 143d and above the connecting pin 143i. Further, a slide supporting rod 143k is provided at the slide end sides of the outer arms 143b that is sides to which outer rollers 143h are shaft-supported. And two hydraulic cylinders 143c are attached between this slide supporting rod 143k and the hoisting/lowering supporting rod 143j.

Further, when the oil pressure in the hydraulic cylinder 143c is increased, the intersection angle between the inner arm 143a and the outer arm 143b is reduced so that the hoisting/lowering frame 141 is hoisted. On the contrary, when the oil pressure in the hydraulic cylinder 143c is decreased, the intersection angle between the inner arm 143a and the outer arm 143b is increased so that the hoisting/lowering frame 141 is lowered. And finally the hoisting/lowering frames 141 are accommodated into the traveling carriage 120. It should be noted that the frames 141 overlie the recess of the carriage 120 within its side walls.

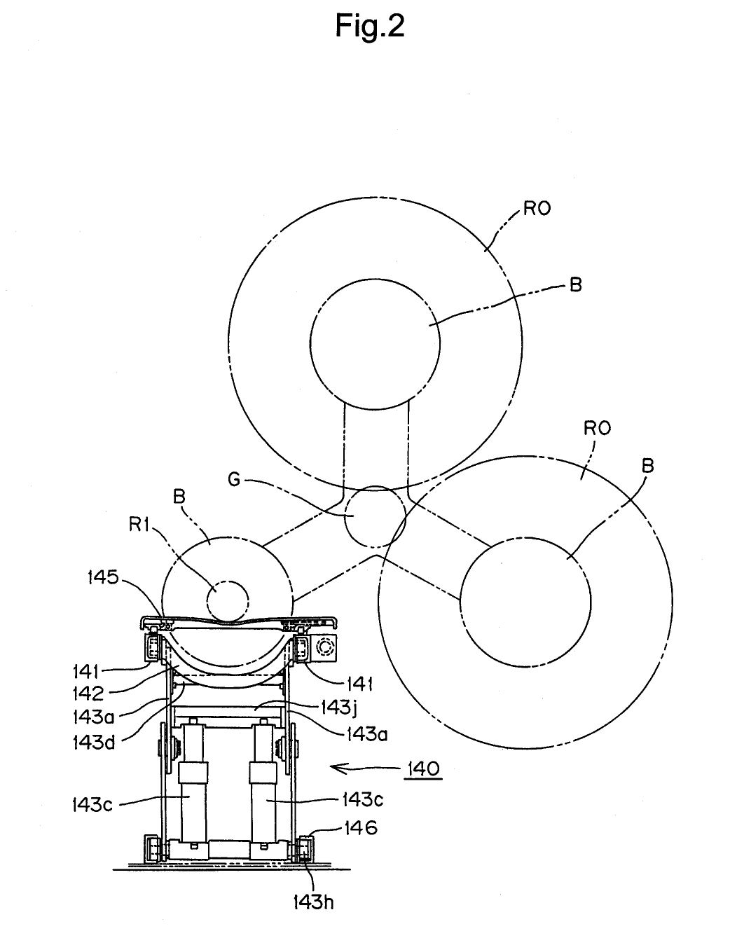

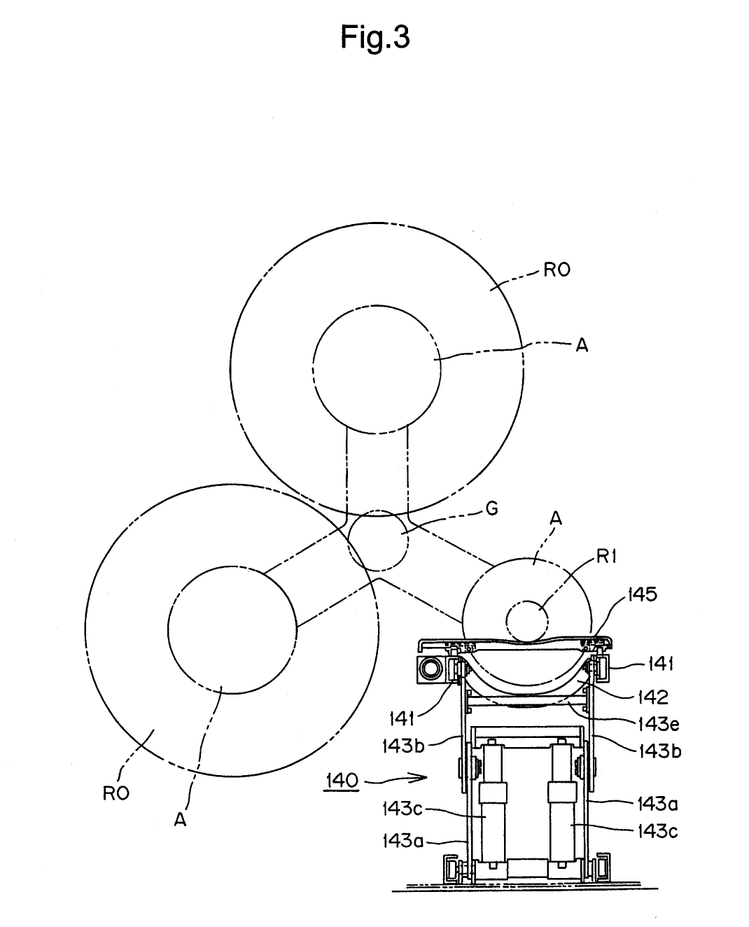

Next, a relationship between the hoisting/lowering unit 140 provided in the automated guided vehicle of the present invention will be described with reference to FIGS. 2 and 3. It is noted that in FIGS. 2 and 3, illustration of a traveling carriage 120 is omitted. In FIGS. 2 and 3, the reference mark G denotes a trifurcated reel of a paper feeding device in a rotary press machine. To this trifurcated reel G are attached unused rolls R0 of newsprint or other printing paper and a roll of newsprint or other printing paper R1 which is in use. The roll R1 in use is disposed on a moving table 145 in the hoisting/lowering unit 140. A moving side winding paper holding arm B and a fixed side winding paper holding arm A sandwich the roll R1 between them.

The pair of hoisting/lowering frames 141 is kept at a required spacing by an arc-shaped connecting member 142. An inner distance keeping rod 143d (see FIG. 2) keeps the required spacing between the inner arms 143a and an outer distance keeping rod 143e (see FIG. 3) keeps the required spacing between the outer arms 143b. The rods 143d and 143a are attached at positions lower than the lower most surface of an inner circumference of the arc-shaped connecting member 142 when the hoisting/lowering frame is positioned in the vicinity of upper limit of a hoisting range. Therefore, the fixed side winding paper holding arm A and the moving side winding paper holding arm B can sandwich a newsprint roll R1 disposed on the moving table 145 without interfering with any portions of the hoisting/lowering unit 140.

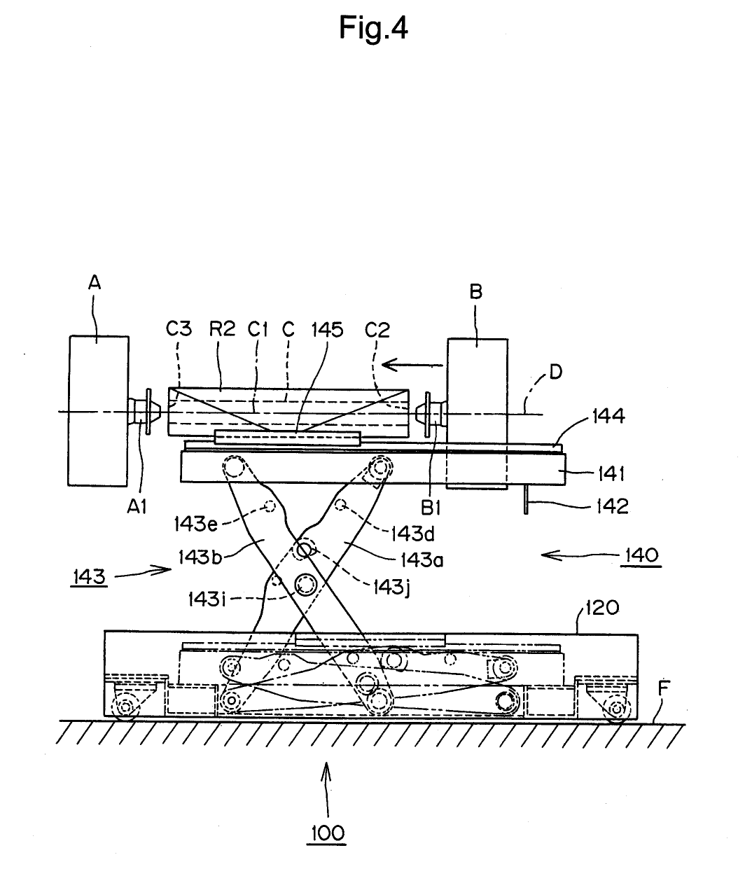

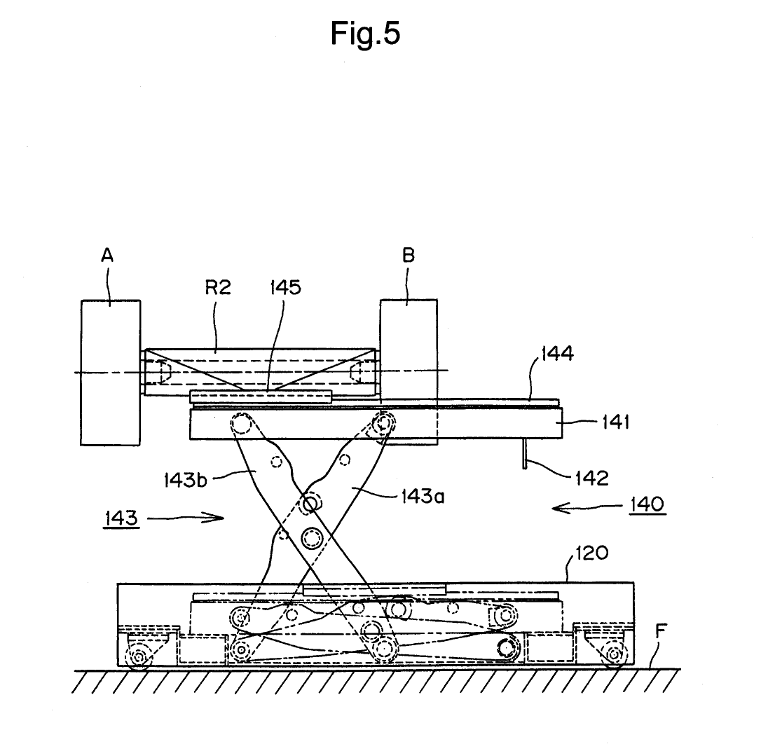

Then, an operation when the hoisting/lowering unit 140 provided in the automated guided vehicle of the present invention attaches the newsprint roll R2 in use to a paper feeding device will be described with reference to FIGS. 4 and 5. The automated guided vehicle 100 loading the newsprint roll R2 on the moving table 145 is advanced under a paper feeding device in a rotary press machine opposite to the fixed side winding paper holding arm A and the moving side winding paper holding arm B. At this time since components of the hoisting/lowering unit 140 are in a state where they are all accommodated in the traveling carriage 120, as shown in the dot-and-dash lines, even if the distance between the paper feeding device and a traveling floor surface F is short, the automated guided vehicle 100 can be smoothly advanced under the paper feeding device. The hoisting/lowering unit 140 hoists the newsprint R1 disposed on the moving table 145 to an upper position so that the central axis C1 of a wound core of the newsprint R1 is arranged at a position corresponding to the central axis D between the central axes of the fixed side cone A1 and the central axis of the moving side cone B1. The moving side winding paper holding arm B is horizontally moved in toward the fixed side winding paper holding arm A so that the moving side cone B1 is fitted to the open end C2 of the core C of the newsprint roll R2.

Further, when the moving side winding paper holding arm B is moved toward the fixed side winding paper holding arm A, the moving table 145 loading the newsprint R1 is slid on the linear guide 144 formed on the hoisting/lowering frame 141 so that the fixed side cone A1 of the fixed side winding paper holding arm A is fitted to the other open end C3 of the core C of the newsprint R1. As a result, as shown in FIG. 5, the engagement of the newsprint roll R2 with the paper feeding device of the rotary press machine is completed.

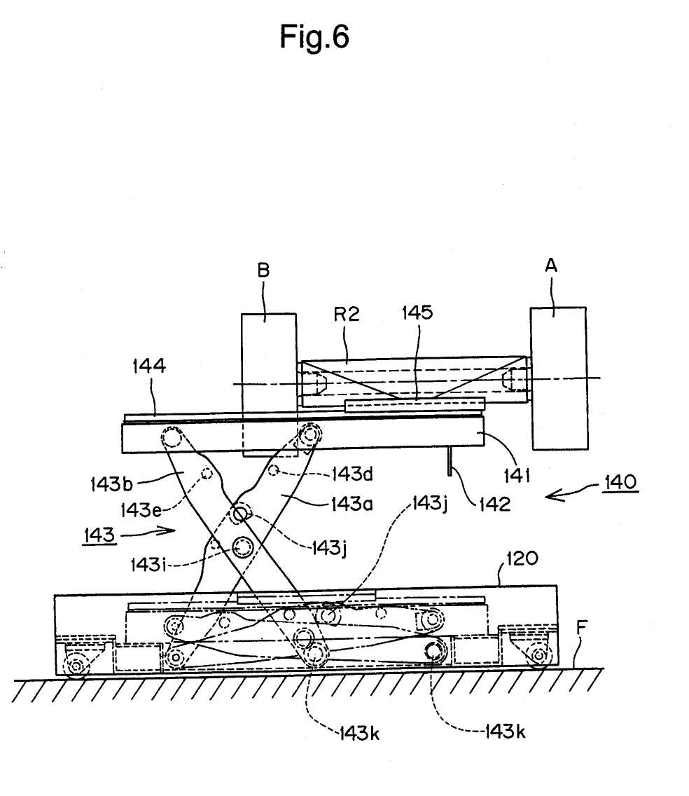

It is noted that in the above-mentioned example, a case where a fixed side winding paper holding arm A is on the left side and a moving side winding paper holding arm B positioned on the right side is horizontally moved for attaching a newsprint thereto so called a case of left justification has been described. However, as shown in FIG. 6, even in a case where the fixed side winding paper holding arm A is on the right side and the moving side winding paper holding arm B positioned on the left side is horizontally moved for attaching a newsprint thereto so called a case of right justification, the same function as in the former case can be obtained.

As described above, since the automated guided vehicle of the present invention does not use a hoisting/lowering base which a conventional automated guided vehicle had, and a pair of hoisting/lowering frames support a moving table 145, and a connecting member 142, which keeps the distance between the hoisting/lowering frames 141 to a required distance, is formed to be in an arc-shape, as shown in FIG. 2, the moving side winding paper holding arm B of a rotary press machine can be brought into closer to a newsprint R1 on the moving table 145 without interfering with the hoisting/lowering unit 140. As a result, the newsprint automated guided vehicle of the present invention can be adapted to various types of rolls of newsprint such as narrow, medium and wide irrespective of their diameters. Since a bulk increasing base which was necessary in the prior art apparatus is not required, low bedding can be realized and since a hoisting/lowering base is not used, weight lightening and the energy saving can be attained. Further, since the upper portion of the automated guided vehicle is open, inspection of the inside of the automated guided vehicle become easy and an improvement of the maintenance performance can be realized. The effects of the present invention are very large.

1. An automated guided vehicle comprising a traveling carriage, which automatically transports rolls of paper across a road surface between a storage station and a setting area in a rotary press machine having opposed paper holding arms to receive a roll of paper therebetween, and a hoisting/lowering unit mounted on said traveling carriage, which hoists and lowers a roll of paper in the vertical direction into and out of registry with the opposed paper holding arms, wherein said hoisting/lowering unit includes
two hoisting/lowering frames provided in parallel to the road surface for supporting a roll of paper thereon,
hoisting/lowering means having a bottom support in said carriage and operable to hoist and lower said hoisting/lowering frames,
an arc-shaped connecting member spanning between said two hoisting/lowering frames to maintain a spacing between said frames, said arc-shaped member avoiding interference with said paper holding arms when said frames are hoisted to cause the supported roll of paper to register with said opposed paper holding arms,
linear guides on upper surfaces of said two hoisting/lowering frames, and
a moving table for the supported roll of paper, said table bridging over said linear guides, and operable to slide along said guides.

2. An automated guided vehicle according to claim 1 for use with a rotary press whose paper holding arms have roll-holding cones aligned along a central axis, said linear guides being parallel to said central axis, said hoisting/lowering unit having an upper position wherein the supported roll is aligned with said central axis in which the roll may be slid into engagement with one of the cones, said arc-shaped connecting member when in said upper position avoiding interference with said paper holding arms.

3. An automated guided vehicle according to claim 1, wherein
said hoisting/lowering means has a pair of arms forming an X-shaped pantograph, one of said arms having one end pivoted to said hoisting/lowering frame and the other end mounted for sliding movement along said hoisting/lowering bottom support, the other of said arms having one end pivoted to said hoisting/lowering supports, and the other end mounted for sliding movement along said hoisting/lowering frame.

4. An automated guided vehicle according to claim 2 wherein
said hoisting/lowering means has a second pair of arms forming a second X-shaped pantograph,
said arms of each pantograph comprising an inner arm and an outer arm,
said inner arms of the two pantographs having an inner distance keeping rod spanning between them,
said outer arms of the two pantographs having an outer distance keeping rod spanning between them,
said inner and outer distance keeping rods being positioned so as to avoid interference with the paper holding arms of the rotary press machine when said hoisting/lowering means positions the supported roll in registry with said paper holding arms.

5. An automated guided vehicle according to claim 4 for use with a rotary press whose paper holding arms have roll-holding cones aligned along a central axis, said linear guides being parallel to said central axis, said hoisting/lowering unit having an upper position wherein the supported roll is aligned with said central axis in which the roll may be slid into engagement with one of the cones, said arc-shaped connecting member and said inner and outer distance keeping rods, when in said upper position, avoiding interference with said paper holding arms.

6. An automated guided vehicle according to claim 1 wherein said carriage has side walls defining a recess for receiving said hoisting/lowering means as it is operated between a lowered position and an hoisted position, said two hoisting/lowering frames overlying said recess adjacent said sidewalls to provide a spacing between said frames which extends substantially the full width of said recess, to afford inspection of said hoisting/lowering means when in its lowered position within said recess.
